(19) United States
(12) Patent Application Publication
(10) Pub. No.: US 2009/0169059 A1
(43) Pub. Date: Jul. 2, 2009

(54) Motion Analysis in Digital Image Sequences

(76) Inventors: Bernd Kleinjohann, Borchen (DE); Christian Reimann, Salzkotten (DE); Christian Schneider, Düsseldorf (DE); Dirk Stichling, Paderborn (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,520

(22) PCT Filed: Feb. 27, 2007
(86) PCT No.: PCT/EP2007/051847

§ 371 Date: Jan. 9, 2009

(30) Foreign Application Priority Data
Mar. 1, 2006 (DE) 10 2006 009 774.2

(51) Int. Cl. G06K 9/00

(52) U.S. Cl. 382/107

(57) ABSTRACT

The invention relates to methods for determining a motion vector in a predetermined area of a sequence of digital images by comparing a current image to a preceding image. The current image and the preceding image are prepared by the same filter for image adaptation. Distance vectors between a pixel of a current image and balanced pixels of the preceding image in a predetermined environment are determined, said distance vectors being averaged in order to form a displacement vector for the pixel. The displacement vectors are averaged and the displacement vector is produced.

The invention relates to analyzing the motion of real objects in digital image sequences.

It is expedient to influence the image contents by real objects visible in the image, particularly in ‘augmented reality’ applications in which virtual objects are superposed in a real video feed. A simple example of such an application is described in the article by V. Paelke, Ch. Reimann and D. Stichling, “Foot-based mobile Interaction with Games”, ACE2004, Singapore, June 2004, in which a virtual football is intended to be struck by the real foot of the player. Equipment is needed for this purpose which determines the motion of the foot from the video image.

One of the methods known for this purpose determines edges in the video image and motion-analyzes the extracted edges based on this. In order to be able to determine the edge motion, a first step attempts to approximate the edges by polylines. This is also holds in the abovementioned article; see p. 2, left-hand column, paragraph under FIG. 2, first sentence: “To perform collision detection, straight edges inside the ROI are vectorized and tracked between two consecutive images”. Straight edges (in the region of interest (ROI)) are vectorized and their motion is reconstructed. For this purpose, the vectorized edges of the two images of a sequence have to be assigned to one another taking into account that the new vector can have both a different spatial position and a different length, but both values are below a predetermined boundary. These calculations are relatively complex.

Other methods can be found mainly in relation to two keywords: ‘tracking’ and ‘optical flow’. ‘Tracking’ also includes techniques which determine the motion of a camera and are thus not relevant in this case.

An overview of the prior art in the field of ‘tracking’ is provided in the technical report TR VRVis 2001 025, “State of the Art Report on Optical Tracking” by Miguel Ribo, Vienna 2001. For applications of the type mentioned above, all methods with specially prepared objects and all methods in which a model of the object to be followed has to be specified are excluded. The remaining methods either use edge-following or complex matrix operations to determine the motion by means of which minimal deviation of the image information is determined.

This also includes methods described in the article by C.-L. Huang, Y.-R. Choo and P.-C. Chung, “Combining Region-based Differential and Matching Algorithms to Obtain Accurate Motion Vectors for Moving Object in a Video Sequence”, ICDCSWO2, 2002. The Horn-Schunk or Lucas-Kanade methods, which are optical flow methods and specified there, are known. They determine gradients by forming differentials and require substantial computational power. The same holds for the methods illustrated in the article by B. Galvin, B. McCane, K. Novins, D. Mason and S. Mills, “Recovering Motion Fields: An Evaluation of Eight Optical Flow Algorithms”, BMVC98, 1998. Most of the methods mentioned additionally have the disadvantage that they are sensitive toward image interference and require further steps to compensate for the latter.

Motion analysis for sequential video images is also used in MPEG-encoding, where the motion of pixel blocks of a fixed size is determined for compression purposes. In this case it is irrelevant whether this motion corresponds to the motion of image objects; for this reason these methods cannot be used within the scope of ‘augmented reality’. By contrast, the methods described in detail in the following are substantially simpler, faster and more robust than the previously known methods. They do not require a model of the object partially or wholly visible in the image and do not demand vectorization of edges; furthermore they are relatively insensitive toward image noise and other interference which disrupt the edge image in the case of conventional edge recognition.

It concerns a method for recognizing the motion of image sections in digital image sequences, in which the average value of the displacement vectors from every pixel to adjacent pixels is determined after a contour accentuation in a selected section and thereupon the average value of all these displacement vectors is formed and used as a displacement vector for an object visible in the section.

Each individual image of the image sequence is pretreated by known filters before applying the method described in more detail below. These filters are used for reducing the color of the image pixels, reducing the noise and accentuating contours or edges. The type and scope of the pretreatment is intended to be determined depending on the application. When applied in a handheld unit such as a mobile telephone with a camera, it was advantageous to apply all of the following filters.

Colored output images are firstly converted to grayscale values (for example by averaging all color channels of each pixel). Optionally, it is possible to smooth very noisy images by applying a Gaussian filter; by way of example, this can occur if a sensor determines that the surroundings are not very bright. Subsequently, an edge, image is generated from the grayscale image by contour filters. In practice, it is conventional to use the Sobel filter for this purpose. Alternatively, it is also possible to use the Prewitt filter, the Laplace filter or comparable filters for generating an edge image.

In one instance of the invention, a pure black and white image with 1 bit per pixel is used, that is to say the brightness values are reduced to one bit, so that each pixel is, in a binary fashion, either white (0 or “no edge”) or black (1 or “edge”). The threshold value for this conversion can either be fixedly predetermined, or it can be determined relative to the mean or median value of the grayscale. In the following, pixels with the value 1 are described as edge pixels for simplicity, even if the invention does not vectorize edges,

but rather allows determination of the motion without reconstructing edges from pixel motion. Instead of explicitly determining edges, the motion of an image section in two successive images (for example, for implicitly recognizing collision with a virtual object) is calculated according to the invention by two nested steps which only refer to the pixels of the image. These pixels are preferably the above-mentioned edge pixels.
1. The motion is calculated for each individual edge pixel (see step 2). Subsequently, the motion of all edge pixels of the image section is averaged. The average is the motion of the overall section and thus of an object which is wholly or partially located in the image section.
2. Since the edge pixels have no attributes (such as brightness, pattern, etc.), it is not possible to unambiguously assign an edge pixel in the current image to an edge pixel in the preceding image. It is for this reason that the motion of an edge pixel with respect to the adjacent edge pixels is calculated by determining displacement vectors with respect to the adjacent edge pixels and averaging these vectors. The vector from the position of the pixel in the current image to the position of a surrounding pixel in the preceding image is described as the (2-dimensional) displacement vector.

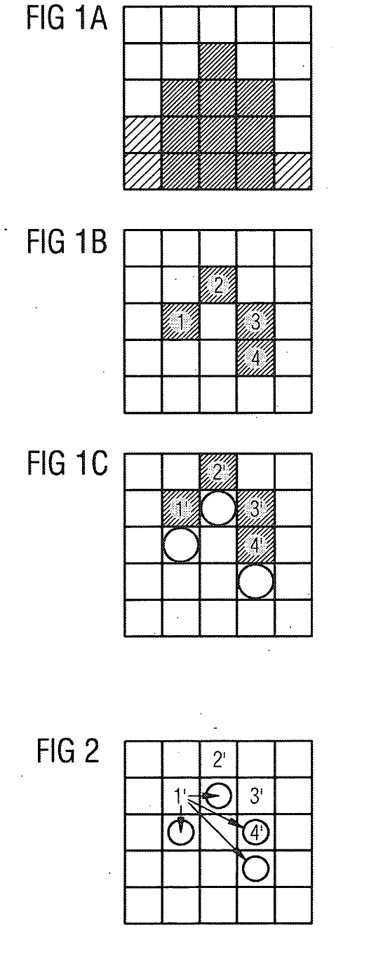

In the following example, a square image section of five by five points is used for simplicity. FIG. 1a shows the input image in grayscale form. After applying an edge filter, four pixels remain, as illustrated in FIG. 1b. The pixels are enumerated for the following description. Suppose that in the subsequent image the object has moved upward. The result is illustrated in FIG. 1c, with the positions occupied in the preceding image being marked by circles.

In a first variant of the invention, the motion is calculated for each edge pixel in the current image (1′, 2′, 3′ and 4′).

In this example the Moore neighborhood is used for this purpose, i.e. all positions which are directly or diagonally adjacent to the current position and the current position itself, that is to say pixels are considered at a predetermined distance. Edge pixel 1′ has two adjacent edge pixels in the preceding image (1 and 2). The averaged motion M_{1′} of 1′ is thus:

$${M}_{{1}^{′}} = \frac{1}{2} [ ( \begin{matrix}0 \\ - 1\end{matrix} ) + ( \begin{matrix}- 1 \\ 0\end{matrix} ) ] = ( \begin{matrix}- 0.5 \\ - 0.5\end{matrix} ) .$$

Correspondingly, the other pixels have the following motion:

$${M}_{{2}^{′}} = \frac{1}{1} [ ( \begin{matrix}0 \\ - 1\end{matrix} ) ] = ( \begin{matrix}0 \\ - 1\end{matrix} )$$

$${M}_{{3}^{′}} = \frac{1}{2} [ ( \begin{matrix}1 \\ 0\end{matrix} ) + ( \begin{matrix}0 \\ - 1\end{matrix} ) ] = ( \begin{matrix}0.5 \\ - 0.5\end{matrix} )$$

$${M}_{{4}^{′}} = \frac{1}{3} [ ( \begin{matrix}1 \\ 1\end{matrix} ) + ( \begin{matrix}0 \\ 0\end{matrix} ) + ( \begin{matrix}0 \\ - 1\end{matrix} ) ] = ( \begin{matrix}0. \overline{3} \\ 0\end{matrix} ) .$$

In order to calculate the overall motion M of the image section, the average of all the individual motions is determined:

$$M = \frac{1}{4} ( {M}_{1} + {M}_{2} + {M}_{3} + {M}_{4} ) = ( \begin{matrix}0.08 \overline{3} \\ - 0.5\end{matrix} ) .$$

It can be seen that a strong upward motion (−0.5) and a very small motion to the right (0.083) were detected.

All points whose pixel value has changed are used in an alternative method of calculation. FIG. 2a is provided for an overview of this; in this case the black blocks have been removed and the circles are smaller compared to FIG. 1c for clarity's sake. Points whose pixel values have changed in this example are points 1 to 3, which are not encircled. Point 4 is not considered because the pixel value has not changed. A distance vector is formed from each of the (changed) points 1 to 3 to each of the points in the previous image positioned in the section; this is indicated for point 1 in FIG. 2a by arrows, and it is listed in the following table; the average value of these vectors is formed by averaging the x- and y-values and it constitutes the final column, with MW representing the average value:

| Point | 1 | 2 | 3 | 4 | MW |
|---|---|---|---|---|---|
| 1 | 0/−1 | 1/0 | 2/−1 | 2/−2 | 1.2/−1 |
| 2 | −1/−2 | 0/−1 | 1/−2 | (1/−3) | 0/1.33 |
| 3 | (−3/−1) | −1/0 | 0/−1 | 0/−2 | −0.33/−1 |
| (4) | | | | | |
| MW | | | | | 0.29/−1.1 |

Here, only those points are taken into account which are within a predetermined neighborhood of the respective point; in this example these are two pixels in the x-direction and y-direction, that is to say a Moore neighborhood with a range of 2. It is for this reason that the vectors for the distance from the new point 2 to the old point 4, and the new point 3 to the old point 1, are discarded and surrounded by brackets. Compared to the previous variant, only pixel values that changed were taken into account but a larger area was considered.

A new average is formed from the average values of the points in an analogous manner and it already represents the result. This also correctly results in an upward motion. The value of the actual displacement is 0/−1.

Black and white images were used in the two examples, with the black pixels corresponding to edges due to filters, and only these black pixels being taken into account. However, the invention is not limited to this. If a higher accuracy is required in return for higher computational power, the method can also be applied to grayscale or color images.

In this case, all pixels of the preceding image which are equivalent to a pixel in the current image are firstly determined for said pixel in the current image. In the case of grayscale images, these are pixels having the same grayscale value with respect to a predetermined boundary of the deviation; in the case of 8 bit or 256 grayscale values these could be 8 grayscale values, for example. Alternatively, it is possible that the grayscale image is firstly quantized by only using 16 grayscale values from the possible 256 grayscale values, with the other values being rounded to these 16 values, and then using exact equality of the pixel values. Both methods result in slightly different equivalences, because the quantization is too different. In the examples illustrated above, 1 bit quantization was carried out after edge filtering and prior to determining equivalent pixels, and the white pixels remained unused. Thus, it was firstly quantized and then only pixels in a predetermined interval were used, in this case only the black pixels. Since the color or grayscale value only corresponds to 1 bit in this case, only the equality of pixel values is meaningful. The invention can be used in an ‘augmented reality’ application to effect interaction between real and virtual objects with little computational complexity. By way of example, a mobile telephone is used which comprises a camera on the rear side and a screen on the front side, and the camera image is reproduced on the screen so that it seems as if the background scene can be seen through the screen. The virtual object is a ball, as in the case of the article mentioned in the introduction. The invention specifies a substantially improved method for recognizing the movement of a real foot and the strike in the direction of and onto the virtual ball. By contrast, the known methods described in the abovementioned article could only be used by delegation in real time to a more powerful computer connected over a network.

1.-7. (canceled)

8. A method for determining a motion vector in a predetermined area in a sequence of images, comprising:
filtering a preceding image in the sequence of images;
identically filtering a current image in the sequence of images;
comparing the current image with the preceding image;
determining distance vectors between a pixel in the predetermined area of the current image and an equivalent pixel of the preceding image;
averaging the distance vectors to form a displacement vector for the pixel; and
determining the motion vector based on the displacement vector.

9. The method as claimed in claim 8, wherein pixel values of pixels in the current image and in the preceding image are quantized after the filtering.

10. The method as claimed in claim 9, wherein the pixels having the pixel values in a predetermined interval are used.

11. The method as claimed in claim 9, wherein the pixels in the current image are equivalent to the pixels in the preceding image after the filtering if a difference of the pixel values of the pixels in the current image and in the preceding image is within a predetermined boundary.

12. The method as claimed in claim 9, wherein the pixel values are binary quantized and the pixels having one of two possible values are used.

13. The method as claimed in claim 12, wherein a plurality of displacement vectors are formed with respect to adjacent pixels in the preceding image.

14. The method as claimed in claim 13, wherein the displacement vectors of the pixels having different pixel values in the preceding image are used.

15. A method for recognizing an impulsive motion of a real object in a predetermined area in a sequence of images, comprising:
filtering a preceding image in the sequence of images;
identically filtering a current image in the sequence of images;
comparing the current image with the preceding image;
determining distance vectors between a pixel in the predetermined area of the current image and an equivalent pixel of the preceding image;
averaging the distance vectors to form a displacement vector for the pixel;
determining a current motion vector for the current image based on the displacement vector;
determining a preceding motion vector for the preceding image by repeating the above steps with respect to a further preceding image in the sequence of images;
comparing the current motion vector with the preceding motion vector; and
recognizing the impulsive motion when a change of the comparison exceeds a predetermined boundary.

16. A system for recognizing an impulsive motion of a real object with respective to a virtual object in an area surrounding the virtual object in a sequence of images, comprising:
a processor that:
filters a preceding image in the sequence of images,
identically filters a current image in the sequence of images,
compares the current image with the preceding image,
determines distance vectors between a pixel in the predetermined area of the current image and an equivalent pixel of the preceding image,
averages the distance vectors to form a displacement vector for the pixel,
determines a current motion vector of the current image based on the displacement vector,
determines a preceding motion vector for the preceding image by repeating the above steps with respect to a further preceding image in the sequence of images,
compares the current motion vector with the preceding motion vector,
recognizes the impulsive motion when a change of the comparison exceeds a predetermined boundary, and
applies the impulsive motion to the virtual object; and
a screen that displays the impulsive motion.
